(19) United States
(12) Patent Application Publication
(10) Pub. No.: US 2016/0280976 A1
(43) Pub. Date: Sep. 29, 2016

(54) TWO-COMPONENT ADHESIVE

(71) Applicant: NOLAX AG, Sempach Station (CH)

(72) Inventor: Stephan BUSER, Sursee (CH)

(21) Appl. No.: 15/034,238

(22) PCT Filed: Oct. 24, 2014
(86) PCT No.: PCT/EP2014/072842

§ 371 Date: May 4, 2016

(30) Foreign Application Priority Data
Nov. 12, 2013 (EP) 13192537.2

(51) Int. Cl. C09J 175/02; C08G 18/72; C08G 18/10; C08G 18/64; C09J 175/04; C08G 18/16

(52) U.S. Cl. CPC C09J 175/02; C09J 175/04; C08G 18/16; C08G 18/10; C08G 18/6423; C08G 18/72

(57) ABSTRACT

A two-component adhesive comprising a first component (A) and a second component (B). First component contains a monomeric polyisocyanate, more particularly monomeric diisocyanate, and an isocyanate-terminated prepolymer and/or a prepolymer mixture with isocyanate functionality ≧1.7, preferably in the range of 1.7<f_{NCO}<3, more preferably in the range of 2<f_{NCO}<3. The second component contains a di- and/or polyamine, preferably a polyether diamine and/or a polyether polyamine, and also at least one trimerization catalyst. The stoichiometric ratio of isocyanate groups in the first component (A) to isocyanate-reactive hydrogen atoms present in the composition, more particularly reactive hydrogen atoms of the di- and/or polyamine, in the second component (B), is from 7.5 to 25, preferably from 10 to 20, particularly preferably 15. A two-component adhesive of this type has better handling properties and is more versatile and, after hardening, it is strong and has low brittleness.

The invention relates to a two-component adhesive and to a two-component adhesive system according to the preamble of the independent claims.

Polyurethanes (PUR) are often used as a basis for structural adhesives and are formed the reaction of di- or polyalcohols with polyisocyanates. Polyurethane adhesives typically achieve a strength between 15-25 MPa with relatively great hardness and brittleness.

Adhesives based on polyurea are likewise known; in their production; in contrast to PUR, the polyol component is replaced by polyamines. The reaction between the amine groups and the isocyanates proceeds more quickly by approximately one order of magnitude than that between the hydroxyl groups of the polyol components and the isocyanates of the polyurethane adhesives. Accordingly, the urea formation is accompanied, in contrast to urethane formation, by a release of heat energy. Adhesives based on polyurea have similar properties to polyurethane adhesives with regard to the relatively great hardness and brittleness.

The formation of trimeric heterocyclic isocyanurates to give polyisocyanurates (PIR) while using trimerization catalysts is known. Two-component adhesives based on the formation of a polyisocyanurate are likewise known. They utilize the reaction of an isocyanate with isocyanate-reactive hydrogen, for example of a polyol or polyamine, using a catalyst. EP 2 137 224 B1 describes a two-component adhesive of this type. Even in the presence of corresponding catalysts, high temperatures are required for the curing, which requires heating of the glued joint and/or temporary storage in a heating oven. Consequently, the use of polyisocyanurate-based two-component adhesives has hitherto been subject to application restrictions.

It is therefore an object of the invention to overcome the disadvantages of the prior art. In particular, the aim is to provide an adhesive composition which can be handled more easily, is more widely applicable and, after curing, is strong and at the same time nevertheless less brittle.

These objects are achieved by the features defined in the independent claims.

The invention relates to a two-component adhesive comprising a first component (A) and a second component (B).

Component A comprises a monomeric polyisocyanate, in particular monomeric diisocyanate, and an isocyanate-terminated prepolymer and/or a prepolymer mixture with an isocyanate functionality ≧1.7, preferably in the range from 1.7<f_{NCO}<3, particularly preferably in the range from 2<f_{NCO}<3.

Particularly preferably, the isocyanate-terminated prepolymer and/or prepolymer mixture is liquid or pasty at room temperature (20° C.), in any case not solid. Room temperature is understood here and below as being 20°. The isocyanate content of the prepolymer and/or prepolymer mixture is in particular 6-33% by weight, preferably 8-25% by weight.

Component B comprises a di- and/or polyamine, preferably a polyetherdiamine and/or a polyetherpolyamine, and at least one trimerization catalyst.

The stoichiometric ratio of isocyanate groups in the first component (A) to isocyanate-reactive hydrogen atoms present in the composition, in particular reactive hydrogen atoms of an amine, in the second component (B) is 7.5 to 25, preferably 10 to 20, particularly preferably 15.

In preferred embodiments, the monomeric diisocyanate of component A is used in the excess described previously.

Particularly preferably, the component B, in particular the di- and/or polyamine, preferably the polyetherdiamine and/or the polyetherpolyamine, is liquid or pasty at room temperature, in any case not solid. Furthermore, the component B can comprise polyols for modifying the impact strength of the fully reacted adhesive, as well as further additives such as e.g. wetting agents, stabilizers, dyes, fillers, water scavengers.

It is possible to dispense with the presence of an isocyanate-terminated prepolymer and/or of a prepolymer mixture in component A. Instead, component A can comprise the reactants (di/polyisocyanates on the one hand and di/polyols and/or di/polyamines on the other hand) for the formation of an isocyanate-terminated prepolymer and/or prepolymer mixture.

Consequently, a two-component adhesive is provided in which, in a first step, a second prepolymer is formed via a reaction, of the monomeric polyisocyanate present in excess (in particular the diisocyanate) with the polyamine. This reaction is strongly exothermic. At the same time, a crosslinking of the isocyanate-terminated prepolymer of component A by amines provided in the component B takes place. As the reaction proceeds further, the influence of appropriate catalysts, in particular potassium octoate, results predominantly in a trimerization of the isocyanate groups present. Thus, compared to known polyurethane and polyurea adhesives, the two-component adhesive according to the invention has both higher tensile strength and thermal stability as well as higher impact strength than other high-strength adhesives such as, for example, epoxide resins.

In particularly preferred embodiments, the isocyanate-terminated prepolymer or prepolymer mixture in component A is a polyurethane or polyurea prepolymer, optionally in a mixture with further isocyanates, for example monomeric diisocyanates, polymeric isocyanates, or monofunctional isocyanates. As already mentioned above, it is indeed possible to dispense with the presence of prepolymers entirely and instead for the corresponding reactants (di/polyisocyanates on the one hand and di/polyols and/or di/polyamines on the other hand) for producing a prepolymer to be present in the component A. The use of polyurethane prepolymers or polyurethane prepolymer mixtures, however, is preferred in the context of the invention: through this, the good adhesion of polyurethane compositions known from the prior art discussed above can be further utilized.

Individual constituents of compositions according to the invention are explained in more detail below.

Isocyanates

Polyisocyanates are essential for producing polyurethanes and polyureas. The general empirical formula of polyisocyanates is R—(NCO)ₙ, where n≧2, and where R is an aromatic or aliphatic group. Polyisocyanates that react with hydroxyl groups form polyurethanes, and polyisocyanates that react with amine groups form polyureas.

The polyisocyanates used are preferably diisocyanates, particularly preferably selected from the group consisting of 4,4′-methylenebis(phenyl isocyanate) (MDI); toluene diisocyanate (TDI); m-xylene diisocyanates (XDI); hexamethylene diisocyanates (HDI); methylenebis(4-cyclohexyl diisocyanates) (HDMI); naphthalene-1,5-diisocyanates (NDI); 3,3′-dimethyl-4,4′-biphenyl diisocyanates (TODI); 1,4-diisocyanatobenzene (PPDI), phenyl-1,4-4-diisocyanates; trimethylhexamethyldiisocyanates (TDMI); isophorone diisocyanates (IPDI); 1,4-cyclohexyl diisocyanate (CHDI); diphenyl ether 4,4′-diisocyanate; p,p′-diphenyl diisocyanate; lysine diisocyanates (LDI); 1,3-bis(isocyanatomethyl)cyclohexane; polymethylpolyphenylisocyanate (PMDI); and isomers and/or mixtures thereof.

Particular preference is given to MDI and polyMDI mixtures. Normally, methylene-bridged polyphenyl polyisocyanate mixtures comprise about 20 to about 100 percent by weight, of MDI isomers (typically about 20 to about 95 percent by weight thereof are allotted to the 4,4′-isomer), while the remainder is formed by polymethylene polyphenylisocyanates with higher functionality (typically about between 2.1 and 3.5) and higher molecular weight. Isocyanate mixtures of this kind are commercially available and/or can be produced easily in accordance with the in U.S. Pat. No. 3,362,979.

The isocyanates can of course be used in the form of higher homologs, for example as isocyanurate, carbodiimide, allophanate, biuret, iminooxadiazinedione, uretoneimine or uretdione.

Prepolymers

Polyurethane Prepolymers

To produce polyurethane prepolymers, polyols are reacted with the aforementioned isocyanates. Suitable polyols are known to the person skilled in the art. In the context of the invention, they typically have a molecular weight of about 500 to about 6000 and/or two to four hydroxyl groups. Particularly preferred polyols are polyesters, polyethers, polythioethers, polyacetals and polycarbonates having in each case 2 to 4 hydroxyl groups. In the context of the invention, preferred polyethers are known per se to the person skilled in the art and can be prepared for example by polymerization of epoxides with ethylene oxide, propylene oxide, butylene oxide, tetrahydrofuran, styrene oxide or epichlorohydrin in the presence of BF₃, or by addition of epoxides, in particular of ethylene oxide or propylene oxide onto molecules containing reactive hydrogens such as, for example, water, alcohol or amines (for example low molecular weight diols, triols or tetrols; 4,4′ dihydroxydiphenylpropane; aniline; ammonia; ethanolamine; ethylenediamine). Polypropylene glycol and polytetramethylene glycol (PTMG or PTMEG) are currently preferred.

In the prepolymer production it is also possible to use chain extenders known per se, in particular di/polyols of low molecular weight (typically less than 400 g/mol). Mention is made in particular of ethylene glycol, propylene glycol, butane glycol, pentane glycol, hexane glycol, benzyl glycol, xylene glycol, water, 1,4-butanediol, 1,3-butanediol, 2,3-dimethyl-2,3-butanediol, dipropylene glycol and tripropylene glycol, di- and triethylene glycol, N-N′-bis-(2-hydroxypropylaniline) (DHPA), 1,4-di(2-hydroxyethyl)hydroquinone (HQEE), diethanolamine, triethanolamine, trimethylolpropane, glycerol.

Polyalkenyl polyols, polyetherpolyols or polyesterpolyols or mixed polyesterpolyetherpolyols having preferably 2 or 3 hydroxyl end groups can be reacted with a well defined excess of isocyanates to give NCO-terminated urethane prepolymers. They are also commercially available for example from Bayer AG, under the trademarks Desmodur® E22 or E23, for example. Distilled products in which the removal of the excess diisocyanate leads to f_{NCO}=2 are likewise known and can be used.

Polyurea Prepolymers

To produce polyurea prepolymers, polyamines with ≧2 amine groups are reacted, in a manner known per se, with a well defined excess of di- or polyfunctional isocyanate compounds to give NCO-terminated polyurea prepolymers.

However, in the context of the invention, polyurea prepolymers are less preferred compared to polyurethane prepolymers since they have a tendency towards gelation at room temperature on account of hydrogen bridge bonds.

Amines

Polyetherpolyamines

Polymeric polyamines components that can be used are preferably compounds with a functionality of 2 to 4, where in particular more than 50% of the active hydrogen atoms are formed from primary or secondary amines. In particular, mention is made of: polyoxyalkyleneamines, such as, for example, polyoxypropylenediamines, polyoxyethylenediamines, polytetramethyleneetherdiamines, polyoxypropylenetriamines, polyoxyethylenetriamines (known under the trade name Jeffamine® from Huntsman); and, if aromatic components are tolerable for a specific application: polyethylene glycol di(p-amino-benzoate); polyethylene glycol di(o-aminobenzoate); polyethylene glycol di(m-aminobenzoate); polytetramethylene glycol di(p-aminobenzoate); polytetramethylene glycol di(o-aminobenzoate); polytetramethylene glycol di(m-aminobenzoate). Polyamines that can be used are polyethylene oxide-polypropylene oxide polyethers, in particular with a functionality of approximately two to approximately three and/or with a molecular weight of approximately 200 g/mol to approximately 6000 g/mol (described for example in U.S. Pat. No. 4,433,067). It is of course also possible to use mixtures of amine-terminated polyethers in the context of the invention.

Preference is given to using polyoxyalkylenediamines with an average molecular weight in the range from about 150 g/mol to about 7500 g/mol, preferably in the range from about 250 g/mol to about 600 g/mol.

Amines as Chain Extenders

In the context of the invention, it is also possible to use aminic chain extenders, preferably with a molecular weight typically less than 400 g/mol. Mention is made, in particular, of aliphatic diamines, as described for example in U.S. Pat. No. 4,246,363 and U.S. Pat. No. 4,269,945. Similarly, a chain-extending aliphatic diamine can be selected from the group consisting of ethylenediamine; neopentanediamine; 1,2- and 1,3-propanediamine; 1,6-hexamethylenediamine; 1,8-octamethylenediamine; 1,12-dodecamethylenediamine; cyclohexylamine; 4,4′-bis(para-aminocyclohexyl)methane; 2,2′-dimethyl-4,4′-methylenebis(cyclohexylamine)(dimethyldicyclane); isophoronediamine; 4,7-dioxadecane-1,10-diamine; 4,7-10-trioxadecane-1,13-diamine, tetramethylethylenediamine; pentamethyldiethylenetriamine; dimethylcyclohexylamine; tetramethyl-1,3-butanediamine; pentamethyldipropylenetriamine; bis(dimethylaminoethyl ether)triethylene glycol diamine; 4,4′-methylenebis(2-ethyl-6-methylcyclohexylamine) (M-MECA); 4,4′-methylenebis(2,6-diethylcyclohexylamine) (MDECA); 4,4′-bis(sec-butylamino)dicyclohexylmethane (commercially available as Clearlink® 1000) and monomers thereof; 3,3′-dimethyl-4,4′-bis(sec-butylamino)dicyclohexylmethanes (commercially available as Clearlink® 3000) and monomers thereof; N,N′-diisopropylisophoronediamine (commercially available as Jefflink® 754); amines of aspartamic acid such as e.g. N,N′-diethyl maleate 2-methylpentamethylenediamine (commercially available as Desmophen® NH-1220), N′N-diethyl maleate-amino)dicyclohexylmethane (commercially available as Desmophen® NH-1420), and N,N′-diethyl maleate-amino)dimethyldicyclohexylmethane (commercially available as Desmophen® NH-1520).

Aromatic diamines (as described for example in U.S. Pat. No. 4,659,747) can also be used as chain extenders in the context of the invention. Specifically, mention is made of: dimethylbenzylamine; diethylbenzylamine; 1,2-dimethylimidazole; 2-methylimidazole; 1,2-, 1,3- or 1,4-bis(sec-butylamino)benzene (commercially available as Unilink® 4100); 4,4′-bis(sec-butylamine)diphenylmethane (commercially available as Unilink® 4200); trimethylene glycol di(p-aminobenzoate) (commercially available as Versalink 740M); trimethylene glycol di-(o-aminobenzoate); trimethylene glycol di(m-aminobenzoate); polyethylene glycol di(p-aminobenzoate); polyethylene glycol di(o-aminobenzoate); polyethylene glycol di(m-aminobenzoate); polytetramethylene glycol di(p-aminobenzoate); polytetramethylene glycol di(o-aminobenzoate); polytetramethylene glycol di(m-aminobenzoate); aromatic diamines such as e.g. 3,5-diethyl-2,4-toluenediamine and 3,5-diethyl-2,6-toluenediamine (commercially available as Ethacure® 100) and 3,5-dimethylthio-2,4-toluenediamine and 3,5-dimethylthio-2,6-toluenediamine (commercially available as Ethacure® 300); 4,4′-methylenebis(2-chloroaniline); diethylenetriamines; triethylenetetramines; tetraethylenepentamine; methylenedianiline (MDA); m-phenylenediamine; diethyltoluenediamine; 4,4′-methylenebis-3-(chloro-2,6-diethylbenzylamine) (MCDEA); diethyltoluenediamines (DETDA); 4,4′-methylenebis(2-ethyl-6-methylanilines (NMMEA); 4,4′-methylenebis(2,6-diethylaniline) (MDEA); 4,4′-methylenebis(2-isopropyl-6-methylaniline) (MMIPA); 4,4′-bis(sec-butylamino)diphenylmethanes; phenylenediamines; methylenebis-ortho-chloroaniline (MBO-CA); 4,4′-methylenebis(2-methylaniline) (MMA); 4,4′-methylenebis(2-chloro-6-ethylaniline) (MCEA);); 1,2-bis(2-aminophenylthio)ethane; N,N′-dialkyl-p-phenylenediamine; 4,4′-methylenebis(2,6-diisopropylaniline) (MDIPA); and dimethylthiotoluenediamine (2,4 and 2,6-isomers) (DMTDA); 4-chloro-3,5-diaminobenzo acid isobutylester (CDABE), and mixtures thereof.

The mixing ratio of the aforementioned chain extenders with the polyamines can be readily matched by the person skilled in the art in routine experiments to the desired ratio of hard and soft segments. Requirements customary in the art placed on the miscibility of the components are to be observed.

In the context of the invention, the aforementioned primary polyamines can be further modified in a manner customary in the art, for example with epoxides (U.S. Pat. No. 6,723,821), with acrylates (via a Michael addition, as described for example in U.S. Pat. No. 5,359,123 and U.S. Pat. No. 5,192,814) or else with alkoxysilanes (preferably with aminosilanes, as described for example in WO02059224), and also with isocyanatosilanes, epoxy silanes or acrylatosilanes.

By virtue of the incorporation of the alkoxysilyl compounds into the isocyanate and/or amine component, these 2C polyurea adhesives can be equipped with an improved profile of properties as regards adhesion, water resistance or acid resistance.

Particularly preferred amines in the component B are polyoxypropylenediamines, preferably with an average molecular weight of about 2000 g/mol (commercially available for example under the trade name Jeffamine® D-2000 according to CAS 9046-10-0; Huntsman Corporation, Houston, Tex.); primary, branched polyethertriamines, preferably with an average molecular weight of about 5000 g/mol (commercially available for example under the trade name Jeffamine® T-5000 according to CAS 64852-22-8; Huntsman Corporation, Houston, Tex. (USA)); substituted, in particular aromatic diamines such as, for example, diethyltolylenediamine (commercially available under the trade name Härter DT or Härter VP LS 2214; Bayer AG, Leverkusen (DE)) or N,N′-dialkylaminodiphenylmethane (commercially available under the trade name Unilink™ 4200 Diamine; UOP GmbH, Erkrath (DE)).

Trimerization Catalysts

Trimerization catalysts according to the invention that can be used are, in particular, metal salts of a carboxylic acid, preferably potassium octoate and potassium acetate, phosphines, sodium hydroxide, potassium hydroxide, quaternary ammonium salts, 2,4,6-tris(dimethylaminomethyl)phenol and/or mixtures of catalysts such as, for example, Jeffcat TR® (Huntsman).

Further aspects of the invention are explained below.

The functionality of the NCO-terminated prepolymers, in particular the urethane prepolymers is ≧1.7, preferably from 1.7<f_{NCO}<3, particularly preferably in the range from 2 to 3. Functionalities >2 can be explained both by additionally present free isocyanates as well as by allophanate groups which are able to form as a result of reaction of urethane groups with further NCO units; prepolymers of this type are therefore often also referred to in the specialist field as “quasi prepolymers”. Allophanate groups in component A are cleaved during the further reaction with component B again into a urethane and free isocyanate.

In preferred embodiments, the stoichiometric ratio of isocyanate groups in component A to isocyanate-reactive hydrogen atoms present in the composition, in particular reactive hydrogen atoms of the di- and/or polyamine, in component B is about 7.5 to about 25, preferably about 10 to about 20, particularly preferably about 15.

By means of the selection and optional combination of different di- or polyamines, in the knowledge of the invention, the person skilled in the art can easily adjust essential properties of the two-component adhesive in routine experiments exclusively via component B, such as e.g. the elasticity, water resistance, reaction rate, etc.; by contrast, component A can be retained, which permits considerable flexibility both from the point of view of production for the manufacturer as well as in the provision for the consumer (system with different components B, see below).

The compositions according to the invention can of course comprise the further additives customary in the art, as are generally customary in the polyurethane/polyurea industry. For example: plasticizers, for example esters of organic carboxylic acids or anhydrides thereof, phthalates, such as, for example, dioctyl phthalate or diisodecyl phthalate. adipates, such as, for example, dioctyl adipate, sebacates, organic phosphoric and sulfonic acid esters, polybutenes and other compounds that do not react with isocyanates; solvents; inorganic and organic fillers, such as, for example, ground or precipitated calcium carbonates which are optionally coated with stearates, carbon blacks, kaolins, aluminum oxides, silicas and PVC powders; fibers, for example of polyethylene or of polyamides; pigments; rheological modifiers such as, for example, thickeners, for example urea compounds, polyamide waxes, bentonites or fumed silicas; adhesion promoters, in particular silanes such as vinyl silanes, isocyanatosilanes in the isocyanate component and aminosilanes reacted with aldehydes to give aldiminosilanes in the amine component; drying agents such as, for example p-tosyl isocyanate and other reactive monoisocyanates, vinyl trimethoxysilane, orthoformic acid esters, calcium oxide or molecular sieve (e.g. zeolites); stabilizers against heat, light and UV radiation; fire-retardant substances; surface-active substances such as, for example, wetting agents, flow agents, deaerating agents or antifoams; fungicides or substances that prevent fungal growth; as well as other substances customarily used in the polyurethane industry.

As regards such additives, reference is made to Polyurethane Handbook 2^{nd} edition, Günter Oertel (editor), Hanser Publishers Munich 1994, pages 98 to 128, the disclosure of which as regards customary additives in the art is hereby incorporated by reference into the disclosure of the present invention.

Suitable substrates are primarily: metals, grass, ceramic, plastics, wood materials, textiles. Advantages are to be found in the area of metal bondings since the compositions convey improved heat resistance and generally higher strengths at room temperature.

Furthermore, the invention relates to a system for the individualized provision of a two-component adhesive comprising a component A with a monomeric polyisocyanate, in particular monomeric diisocyanate, and an isocyanate-terminated prepolymer and/or prepolymer mixture with an isocyanate functionality of ≧1.7, preferably of 1.7<f_{NCO}<3, particularly preferably in the range from 2<f_{NCO}<3, and with at least two alternative components B comprising in each case a different di- and/or polyamine, preferably a polyetherdiamine and/or a polyetherpolyamine, and at least one trimerization catalyst. The stoichiometric ratio of isocyanate groups in the first component (A) to isocyanate-reactive hydrogen atoms present in the composition, in particular reactive hydrogen atoms of the di- and/or polyamine, in the two alternative components (B) is 7.5 to 25, preferably 10 to 20, particularly preferably 15.

By means of such a system (in the sense of an arranged provision for common use (kit-of-parts)), it is possible to provide, on an individualized basis, a two-component adhesive according to the invention surprisingly easily and flexibly exclusively via the application-specific component B to be selected by the consumer.

The invention is illustrated in more detail below by reference to working examples without the subject matter of the inventions being limited to these embodiments.

The index (cf. tables 1 and 2) corresponds to the ratio of molar amount of isocyanate groups used and theoretically required molar amount of isocyanate groups and defines, for a value >1, a molar excess of isocyanate groups used.

Composition 1 Is a non-inventive adhesive composition based on polyurethane from WO 2009/035915 A1. For an index of 1.004 and no use of trimerization catalysts, it has impact strength properties.

TABLE 1
noninventive composition 1 from
WO 2008/095915 A1

| Composition 1 | % by wt. | Component | Manufacturer |
|---|---|---|---|
| Jeffamine D-2000 | 8.5% by wt. | B | Huntsman |
| Jeffamine T-5000 | 1.5% by wt. | B | Huntsman |
| Unilink 4200 | 25.8% by wt. | B | Alfa |
| Härter DT | 3.9% by wt. | B | Bayer |
| Desmodur E23 | 60.32% by wt. | A | Bayer |
| Index | 1.004 | | |
| Properties | Impact | | |
| | resistant | | |

Comparisons of comparative examples (compositions 2 and 3) and inventive compositions (compositions 4 and 5) are summarized below. Different use amounts of Jeffamine D-2000 and Jeffamine SD-401, TIB KAT K15, Polycat 43, Suprasec 2385, Desmodur E23, and addition of Desmophen 4051 B, Tego Wet KL 245 and Siliporite SA/1720 in the components A and B were compared.

The properties of the comparative examples (compositions 2 and 3) and of the inventive compositions (compositions 4 and 5) are shown in the table below. Compositions 2 and 3 are non-inventive compositions. Compositions 4 and 5 are inventive compositions.

TABLE 2
example compositions

| | | | | | Com- | |
|---|---|---|---|---|---|---|
| Compo- | | | | | po- | Manu- |
| sition | 2* | 3* | 4 | 5 | nent | facturer |
| Jeffamine | | | 26.7% | 21.9% | B | Huntsman |
| D-2000 | | | | | | |
| Jeffamine | 27% | 27.5% | | | B | Huntsman |
| SD-401 | | | | | | |
| Desmophen | | | | 2.4% | B | Bayer |
| 4051 B | | | | | | |
| TIB | 0.5% | 0.6% | 1.1% | 1.0% | B | TIB |
| KAT K15 | | | | | | Chemicals |
| Tego Wet | | | | 1.0 | B | Evonik |
| KL 245 | | | | | | |
| Siliporite | | | | 1.0% | B | Arkema |
| SA/1720 | | | | | | |
| Polycat 43 | | | 0.3% | 0.3% | B | AirProd- |
| | | | | | | ucts |
| Suprasec | 72.4% | 36% | 36% | 36.2% | A | Huntsman |
| 2385 | | | | | | |
| Desmodur | | 36% | 36% | 36.2% | A | Bayer |
| E23 | | | | | | |
| Index | 5.1 | 3.7 | 14.9 | 15 | | |
| Properties | Very | Somewhat | Very | Very | | |
| | brittle | brittle | impact | impact | | |
| | | | resistant | resistant | | |

(*denotes comparative examples)

The table below shows the modulus of elasticity (E modulus) and the maximum tensile strength of inventive composition 5 at increasing temperatures. Corresponding measurement values at room temperature are likewise shown for the non-inventive composition 1, which have values of 71% for the E modulus and 58% for the maximum tensile strength of the values of inventive composition 5. A regression of the E modulus and the maximum tensile strength at increasing temperatures is known for composition 1 (data not shown).

TABLE 3
tensile tests in accordance with ISO-527-2

| | | | Composition | Composition |
|---|---|---|---|---|
| | Composition | Composition | 1 | 5 |
| Storage | 1 | 5 | Max tensile strength | |
| temperature | E modulus (MPa) | | (MPa) | |
| Room | 590 | 833 | 23.0 | 39.6 |
| temperature | | | | |
| 80° C. | | 643 | | 30.5 |
| 120° C. | | 209 | | 14.3 |
| 150° C. | | 167 | | 14.1 |
| 180° C. | | 209 | | 10.6 |

The table below gives the tensile shear properties of inventive composition 5.

TABLE 4
tensile shear tests in accordance with
ISO 4587:
Tensile shear strength composition 5 (Alu/Alu, 0.1 mm joint)

| Temperature | Strength (MPa) |
|---|---|
| 20° C. | 9.13 |
| 150° C. | 5.58 |

Inventive compositions 4 and 5 have high impact strength at an index of 14.9 and 15. Moreover, improved tensile strengths are shown for inventive composition 5. The composition also exhibits advantageous properties at storage temperatures in the range from 80 to 150° C.

1-8. (canceled)

9. A two-component adhesive comprising:
a first component (A), and
a second component (B),
where the first component (A) comprises:
a monomeric polyisocyanate; and
at least one of an isocyanate-terminated prepolymer and a prepolymer mixture with an isocyanate functionality ≧1.7;
where the second component (B) comprises:
at least one of a di- and polyamine; and
a trimerization catalyst; and
where a stoichiometric ratio of isocyanate groups in the first component (A) to isocyanate-reactive hydrogen atoms present in the composition in the second component (B) is 7.5 to 25.

10. The two-component adhesive according to claim 9, wherein the monomeric polyisocyanate is a monomeric diisocyanate.

11. The two-component adhesive according to claim 9, wherein at least one of the isocyanate-terminated prepolymer or the prepolymer mixture has an isocyanate functionality in the range from 1.7<f_{NCO}<3.

12. The two-component adhesive according to claim 9, wherein at least one of the di- and polyamine is at least one of a polyetherdiamine and a polyetherpolyamine.

13. The two-component adhesive according to claim 9, wherein the stoichiometric ratio of isocyanate groups in the first component (A) to reactive hydrogen atoms of at least one of the di- and polyamine in the second component (B) is 10 to 20.

14. The two-component adhesive according to claim 9, wherein at least one of the isocyanate-terminated prepolymer and the prepolymer mixture is liquid or pasty at room temperature.

15. The two-component adhesive according to claim 9, wherein at least one of the di- and the polyamine is liquid or pasty at room temperature.

16. The two-component adhesive according to claim 9, wherein the second component (B) comprises at least one of polyols and additives.

17. The two-component adhesive according to claim 9, wherein at least one of the isocyanate content of the prepolymer and of the prepolymer mixture of the first component (A) is 6-33% by weight.

18. The two-component adhesive according to claim 9, wherein at least one of the isocyanate content of the prepolymer or of the prepolymer mixture of the first component (A) is 8-25% by weight.

19. The two-component adhesive according to claim 9, wherein the trimerization catalyst is a metal salt of a carboxylic acid.

20. The two-component adhesive according to claim 9, wherein at least one of the isocyanate-terminated prepolymer and prepolymer mixture in the first component (A) is at least one of a polyurethane and a polyurea prepolymer.

21. A system comprising a two-component adhesive with:
a first component (A) comprising at least one of an isocyanate-terminated prepolymer and a prepolymer mixture with an isocyanate functionality of ≧1.7; and
at least two alternative, second components (B) comprising, in each case, at least one of a different di- and polyamine; and
at least one trimerization catalyst provided either separately or in the at least two alternative second components (B); and
where a stoichiometric ratio of isocyanate groups in the first component (A) to isocyanate-reactive hydrogen atoms present in the composition in the two alternative components (B) is 7.5 to 25.

22. The system according to claim 21, wherein the at least one trimerization catalyst is a metal salt of a carboxylic acid.

23. The system according to claim 21, wherein the at least one of the different di- and polyamine of the at least two alternative, second components (B) is at least one of a polyetherdiamine and a polyetherpolyamine.
